(19) United States
(12) Patent Application Publication
(10) Pub. No.: US 2004/0098426 A1
(43) Pub. Date: May 20, 2004

(54) Backup system, backup method, program for backup, and backup service provision system

(75) Inventors: Shogo Ishii, kawasaki-shi (JP); Satoru Iwahashi, Kawasaki-shi (JP); Masaru Kawashima, Kawasaki-shi (JP)

Correspondence Address: Sean M. McGinn, Esq., McGinn & Gibb, PLLC, Suite 200, 8321 Old Courthouse Road, Vienna, VA, 22182-3817, US

(73) Assignee: Toshiba IT-Solutions Corporation, Kawasaki-shi (JP)

(21) Appl. No.: 10/613,092

(22) Filed: Jul. 7, 2003

(30) Foreign Application Priority Data
Jan. 6, 2001 (JP) 2001-166708

(51) Int. Cl. G06F 12/00

(52) U.S. Cl. 707/204

(57) ABSTRACT

Herein disclosed is a backup system capable of easily performing backup and/or restore operations of an entire hard disk (HD) inclusive of a system region regardless of a type of an OS installed thereon in a computer such as a personal computer (PC). The backup system is suitable for backing up a hard disk of a computer which is connected to a server via a network, and characterized in that the server comprises: a boot OS creation section adapted to create a boot OS for the computer; a backup section adapted to store as a file the content of the hard disk in the computer into a designated backup destination; a management information database adapted to store therein management information of the computer; and a kernel image adapted to serve for the creation of the boot OS, as result of which it is possible to perform the backup and/or restore operations of the hard disk in the computer with easy manipulation by executing backup and restore functions from the boot OS.

### BACKGROUND OF THE INVENTION

1. Field of the Invention

The present invention relates to a backup system for backing up a hard disk (hereinafter, referred to as an HD) in a computer such as a personal computer (hereinafter, referred to as a PC).

2. Description of the Related Art

Conventionally, in order to back up the content stored in an HD 6 in an computer such as a PC 1 as shown in FIG. 26, an OS installed in a system region 61 of the HD 6 is activated such that the content of a user data region 62 of the HD 6 is stored into an external storage device such as a magnetic tape device 63 by using this OS. If it is intended that such a backup operation is performed for only the content of the user data, this conventional backup method is so much fit for its purpose. However, in the cases where it is desired that the backup operation is further performed for the content of the system region 61 in addition to that of the user region 62, there arises a problem that it is impossible to perfectly store the system region 61 because the system region 61 may often be updated even during the backup operation thereof.

Also, when the backup operation is being performed, the capacity of a backup destination must be checked at all times. Accordingly, it is very difficult for a general user who has not an appropriate facility to back up the entire region of the HD 6. Furthermore, in the cases where the backed up content is restored to the original HD 6, there is a possibility that the content of the current HD 6 may be destroyed. Therefore, extra care must be taken on such a backup/restore operation which is delicate and severe work for the general user.

### SUMMARY OF THE INVENTION

In order to address the above-mentioned problem and the other, the present invention has been accomplished. An object of the present invention is to provide a backup system capable of easily executing or performing backup and/or restore operations of the entire hard disk (HD) 6 inclusive of the system region 61 regardless of a type of the OS installed thereon in the computer such as the PC 1.

To achieve the forgoing and other objects, there is provided and claimed in claim 1 a backup system for backing up a hard disk of a computer which is connected to a server via a network, characterized in that the server comprises:

a boot OS creation section adapted to create a boot OS for the computer;

a backup section adapted to store as a file the content of the hard disk of the computer into a designated backup destination;

a management information database adapted to store therein management information of the computer; and

a kernel image adapted to serve for the creation of the boot OS.

To achieve the forgoing and other objects, there is provided and claimed in claim 2 the backup system as claimed in claim 1, wherein the server further comprises a restore section adapted to restore the content of the hard disk into the same hard disk of the computer or into a hard disk of another computer by using the file which has been stored as a file by the backup section.

To achieve the forgoing and other objects, there is provided and claimed in claim 3 a backup system for backing up a hard disk of a computer which is connected to a server via a network,

characterized in that the server comprises:

i) a boot OS creation section adapted to create a boot OS for the computer and to store it into a boot media;

ii) a management information database adapted to store therein management information of the computer; and

iii) a kernel image adapted to serve for the creation of the boot OS,

and further characterized in that the boot media comprises:

iv) a backup section adapted to store as a file the content of the hard disk of the computer into a designated backup destination; and

v) a restore section adapted to restore the content of the hard disk into the same hard disk of the computer or into a hard disk of another computer by using the file which has been stored as a file by the backup section.

To achieve the forgoing and other objects, there is provided and claimed in claim 4 the backup system as claimed in any one of claims 1 to 3, wherein the boot OS creation section includes:

a parameter creating portion adapted to allow the kernel image to serve as the boot OS; and

a writing portion adapted to store the boot OS.

To achieve the forgoing and other objects, there is provided and claimed in claim 5 the backup system as claimed in any one of claims 1 to 4, wherein the backup section includes:

an information managing portion adapted to manage information for backup;

a reading portion adapted to read the content of the hard disk of the computer while compressing it; and

a writing portion adapted to write the compressed content into the designated backup destination.

To achieve the forgoing and other objects, there is provided and claimed in claim 6 the backup system as claimed in any one of claims 1 to 4, wherein the restore section includes:

an information managing portion adapted to manage information for restore;

a reading portion adapted to read a file of a restore origin while expanding it; and

a writing portion adapted to write this expanded content into a hard disk as a restore destination.

To achieve the forgoing and other objects, there is provided and claimed in claim 7 the backup system as claimed in any one of claims 1 to 6, wherein the backup section includes a padding portion adapted to pad an unassigned region in the hard disk of the computer with specific values.

To achieve the forgoing and other objects, there is provided and claimed in claim 8 the backup system as claimed in any one of claims 5 to 7, wherein the information managing portion included in the backup section is adapted to store certification data, and wherein the restore section includes a certifying portion adapted to perform certification using the stored certification data by the information managing portion included in the restore section.

To achieve the forgoing and other objects, there is provided and claimed in claim 9 a method of backing up a hard disk connected to a computer, characterized by comprising the steps of:

creating a boot OS for booting the computer by using an external storage device or via a network, independently of or separately from an OS installed in the computer as a backed-up object;

booting the computer with the boot OS; and

backing up the content of the hard disk connected to the computer into a server via the network, into a storage medium over the network, or into a storage medium directly connected to the computer.

To achieve the forgoing and other objects, there is provided and claimed in claim 10 the method as claimed in claim 9, further comprising the step of restoring the content of the hard disk connected to the computer into a hard disk connected to anther computer by using a file backing up the content of the hard disk of the computer.

To achieve the forgoing and other objects, there is provided and claimed in claim 11 a program executed in a server or a computer via a network, characterized by comprising:

a creating function adapted to create a boot OS for the computer;

a backup function adapted to store as a file the content of a hard disk in the computer into a designated backup destination; and

a restore function adapted to restore the content of the hard disk into the same hard disk in the computer by using the file which has been stored as a file by the backup function.

To achieve the forgoing and other objects, there is provided and claimed in claim 12 a backup service provision system for providing a backup of a hard disk of a computer connected to a server via the Internet, characterized in that the server comprises:

a boot OS creating section adapted to create a boot OS for the computer;

a backup section adapted to store as a file the content of the hard disk in the computer into a designated backup destination;

a management information database adapted to store management information for the computer; and

a kernel image adapted to serve for the creation of the boot OS, and wherein the backup service provision system is configured to back up any computers connectable to the server.

To achieve the forgoing and other objects, there is provided and claimed in claim 13 the backup service provision system as claimed in claim 12, wherein the server further comprises a restore section adapted to restore the content of the hard disk into the same hard disk in the computer by using the file which has been stored as a file by the backup section.

These and other aspects of the present invention will be apparent from the following specific description, given by way of example, with reference to the accompanying drawings.

### BRIEF DESCRIPTION OF THE DRAWINGS

FIG. 1 is an explanatory schematic diagram showing the configuration of a backup system of a first embodiment according to the present invention;

FIG. 2 is a schematic block diagram showing the configuration of a backup server used in the first embodiment;

FIG. 3 is a schematic diagram showing the configuration of a management information DB used in the first embodiment;

FIG. 4 is a schematic diagram showing the configuration of backup data used in the first embodiment;

FIG. 5 is an explanatory schematic diagram showing the configuration of a backup system of a second embodiment according to the present invention;

FIG. 6 is a schematic block diagram showing the configuration of a backup server used in the second embodiment;

FIG. 7 is an explanatory schematic diagram showing the configuration of a backup system of a third embodiment according to the present invention;

FIG. 8 is a schematic block diagram showing the configuration of a backup server used in the third embodiment;

FIG. 9 is an explanatory schematic diagram showing the configuration of a backup system as one application example of the third embodiment;

FIG. 10 is an explanatory schematic diagram showing the configuration of a mixture system of the first, second and third embodiments;

FIG. 11 is a flow chart illustrating a boot OS creation processing pursued in the backup system;

FIG. 12 is a flow chart illustrating a backup processing pursued in the backup system;

FIG. 13 is a flow chart illustrating a restore processing pursued in the backup system;

FIG. 14 is a screen example displayed during the boot OS creation processing according to the present invention;

FIG. 15 is a screen example displayed after that of FIG. 14;

FIG. 16 is a screen example displayed during the backup processing according to the present invention;

FIG. 17 is a screen example displayed after that of FIG. 16;

FIG. 18 is a screen example displayed after that of FIG. 17;

FIG. 19 is a screen example displayed after that of FIG. 18;

FIG. 20 is a screen example displayed during the restore processing according to the present invention;

FIG. 21 is a screen example displayed after that of FIG. 20;

FIG. 22 is a screen example displayed after that of FIG. 21;

FIG. 23 is a screen example displayed after that of FIG. 22;

FIG. 24 is an explanatory schematic diagram showing the configuration of a backup service provision system as a first application example according to the present invention;

FIG. 25 is an explanatory schematic diagram showing the configuration of a backup service provision system as a second application example according to the present invention; and

FIG. 26 is an explanatory schematic diagram showing the configuration of a conventional backup system.

### DESCRIPTION OF PREFERRED EMBODIMENTS

Hereinafter, preferred embodiments according to the present invention will be described in detail with reference to the accompanying drawings.

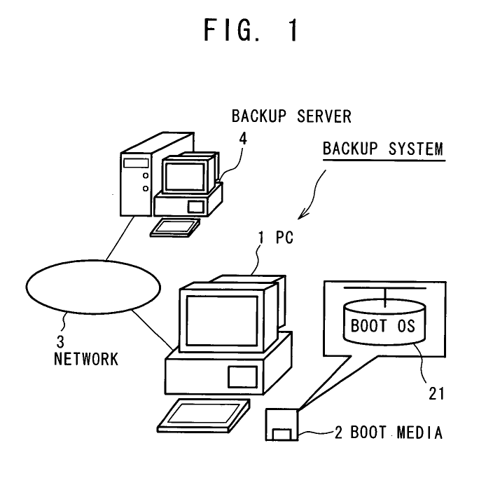

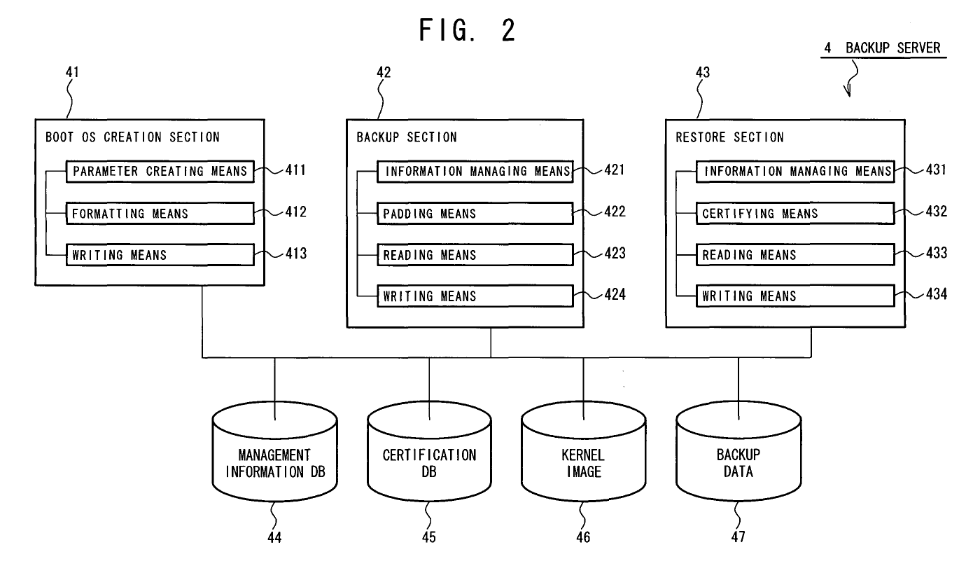

FIG. 1 is a schematic block diagram showing a backup system of a first embodiment according to the present invention. The backup system as shown in FIG. 1 comprises: a PC 1 as an object to be backed up (or backed-up object PC 1); a boot media 2 storing therein a boot OS 21 for booting or starting this backed-up object PC 1; and a backup server 4 connected to this backed-up object PC 1 via a network 3.

The backup server 4 includes: a boot OS creating section 41 for creating the boot OS 21 suitable for booting the PC 1 in order to perform backup and/or restore operations; a backup section 42 for backing up an HD 6 in the PC 1; and a restore section 43 for restoring data which has been backed up. The boot OS creating section 41 contains: parameter creating means 411; formatting means 412 for initializing any media; and writing means 413 for writing the boot OS 21 into the boot media 2 which has already been initialized.

The backup section 42 contains: information managing means 421 for managing information in associated with backup; padding means 422 for padding an unassigned region of the HD 6 in the PC 1 with specific values; reading means 423 for reading the content of the HD 6 in the PC 1 while compressing it; and writing means 424 for writing backup data 47 into a backup destination.

The restore section 43 contains: information managing means 431; certifying means 432; reading means 433 for reading data of a restore origin while expanding it; and writing means 434 for writing the data into a restore destination.

Each of these sections is configured to execute its processing by using a management information database (or management information DB) 44, a certification DB 45, a kernel image 46 and backup data 47.

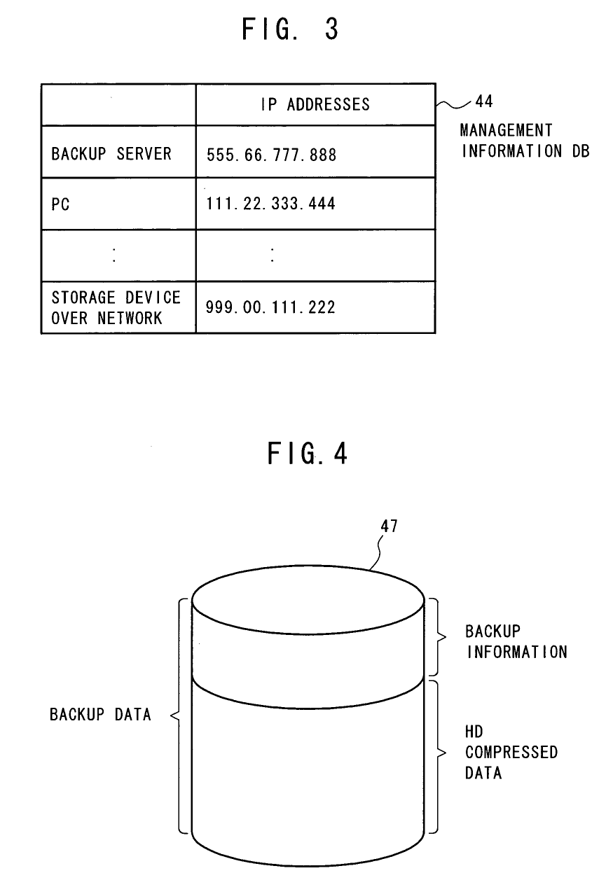

In the management information DB 44 as shown in FIG. 3, there are stored therein IP addresses for various devices over the network 3, the backup server 4, the PC 1, and storage devices and the like over the network 3.

In the kernel image 46, there is stored therein a kernel image for creating the boot OS 21. Parameters for respective PCs are created for this kernel image 46 to create the boot OS 21. In the kernel image 46, UNIX® having the minimum capability, Linux and the like are stored.

In the backup data 47, there are stored therein backup information, such as the date and time of backup and information of the HD 6 (concerning a connection status of the HD 6), and HD 6 data which have been backed up from the PC 1 and made in the compression form.

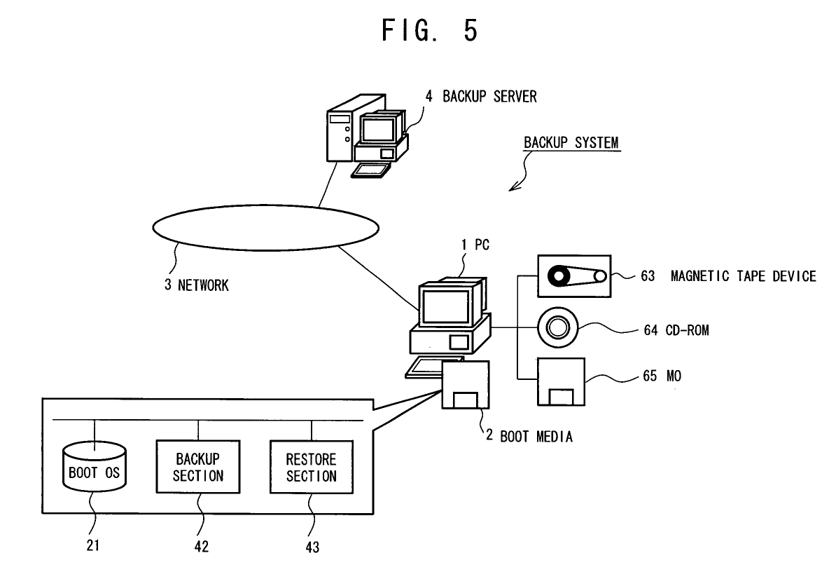

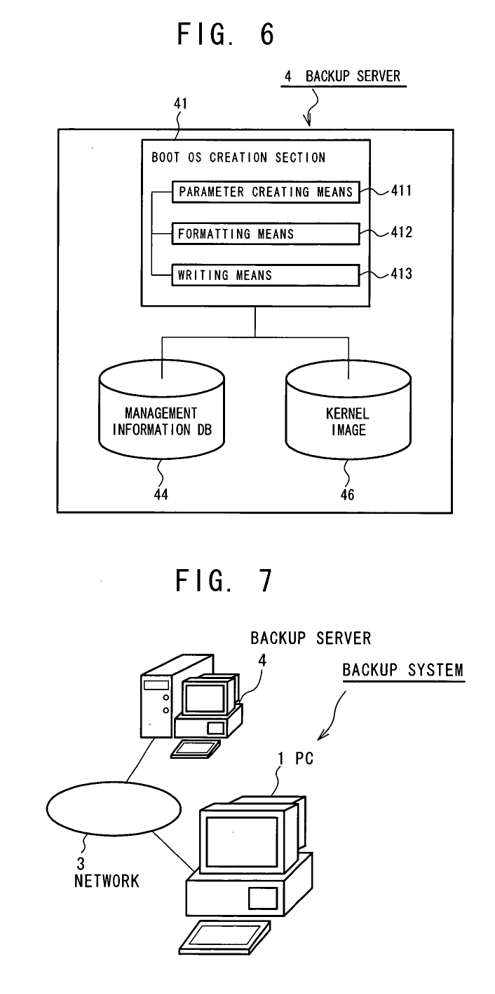

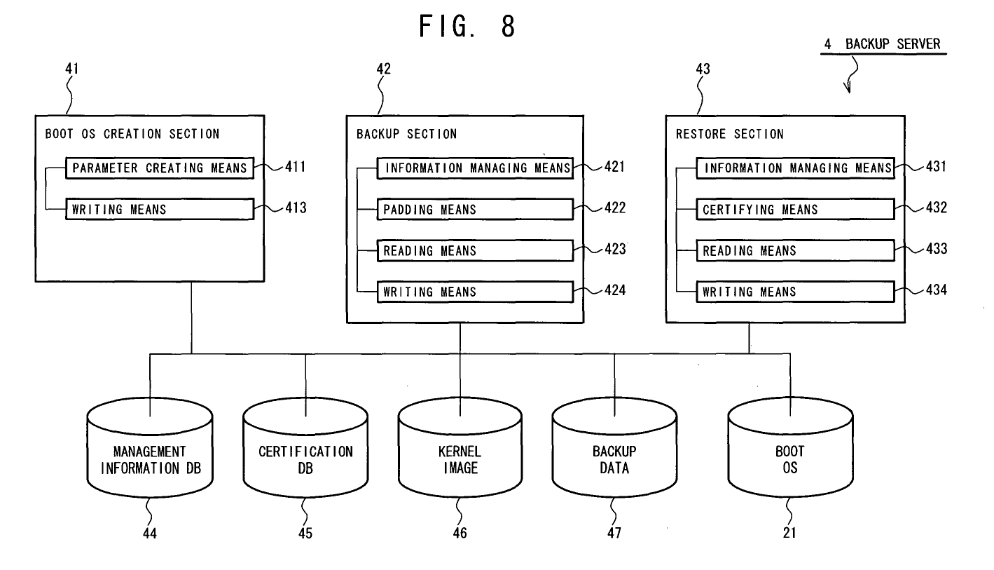

FIG. 5 is a schematic block diagram showing a backup system of a second embodiment according to the present invention. The backup system of the second embodiment is configured to include in its boot media 2 as shown in FIG. 5 the backup section 42 and the restore section 43 which are included in the backup server 4 of the first embodiment. As shown in FIG. 6, the backup server 4 in this backup system comprises: the boot OS creation section 41; the management information DB 44; and the kernel image 46. In the backup system of this second embodiment, the creation of the boot OS 21 is performed in the backup server 4 but the actual backup and/or restore operations are performed singly in the PC 1 without any intervention of the network 3 between the PC 1 and the backup server 4.

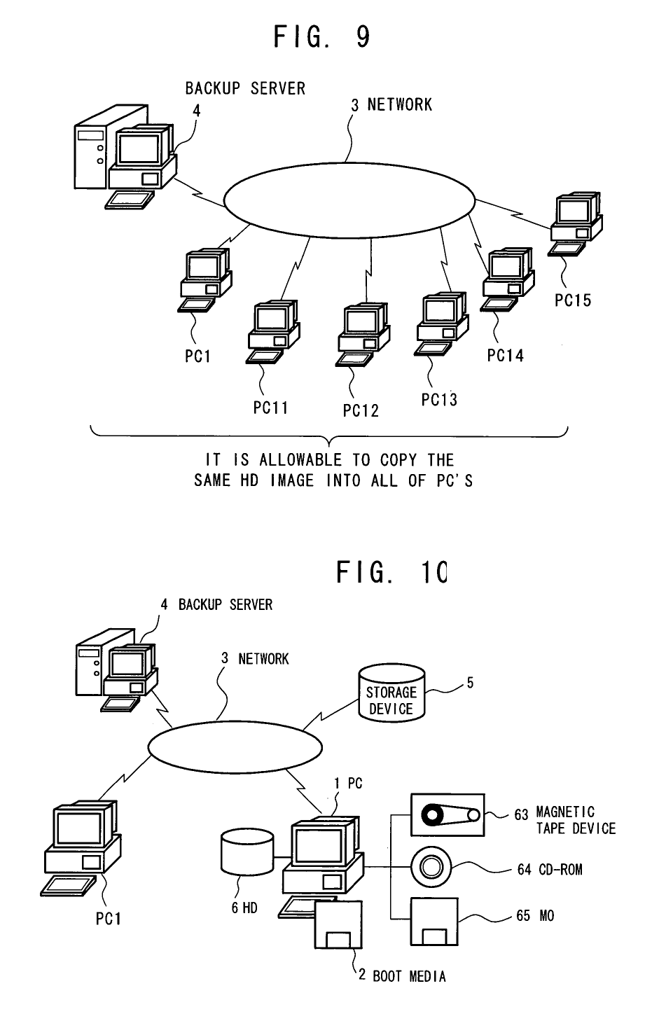

FIG. 7 is a schematic block diagram showing a backup system of a third embodiment according to the present invention. The backup system of the third embodiment is configured to store the OS 21 in the backup server 4 but not in an FD (floppy disk). This configuration is operable on the assumption that the PC 1 is set to be booted based on connection to the network 3 as the BIOS (Basic Input/Output System) setting of the PC 1. That is, it is possible to perform the backup and/or restore operations only by connection to the network 3 without usage of FD containing therein the boot OS. In the cases where the backup and/or restore operations can be performed only by connection to the network 3, a file having thereon the content backing up the HD 6 in the PC 1 is restored in each of PC's 11 through 15 so that the same HD image can readily be copied and created into all (HD's) of the PC's 11 through 15 as shown in FIG. 9.

In particular, according to the present invention, it is possible to configure a mixture system of the first, second and third embodiments as shown in FIG. 10.

The following description is provided to explain a flow of boot OS creation processing pursued in the backup system of the first embodiment with reference to a flow chart of FIG. 11.

In the case where the backup system of the first embodiment is used, an OS capable of booting the backed-up object PC 1 is created by the backup server 4 and then stored in the boot media 2.

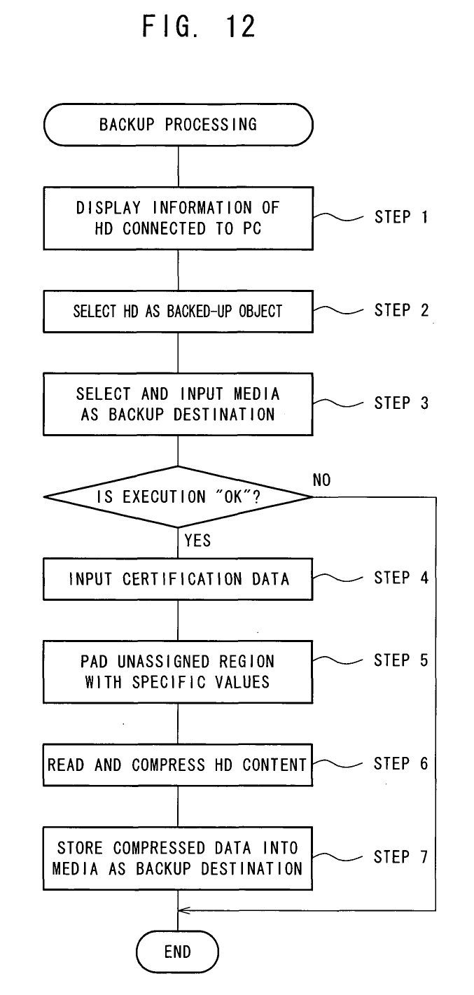

If a user selects a creation tool in the backup server 4 for creating the boot OS 21 for backup, the user is prompted on a screen as shown in FIG. 14 to input an IP address of the backed-up object PC 1 (Step 1), a boot media (or boot media item) into which the boot OS 21 is to be stored (Step 2) and a backup style (Step 3), respectively.

Here, the boot media 2 into which the boot OS 21 is to be stored comprises a storage media such as an FD (floppy disk) or the like. If the BIOS of the PC 1 is set so as to accept a CD or the like for booting the PC 1, not only the FD but also the CD or the like can serve as the boot media 2. Also, if the BIOS of the PC 1 is set so as to accept the boot of the PC 1 via the network 3, the PC 1 can be booted via the network 3 from the backup server 4.

On the other hand, what is indicated by the backup style is either one of a backup to be performed via the network 3 and a backup to be performed locally without intervention of the network 3. The backup to be performed via the network 3 corresponds to the cases as shown in FIGS. 1 and 7 while the backup to be performed locally without intervention of the network 3 corresponds to the case as shown in FIG. 5.

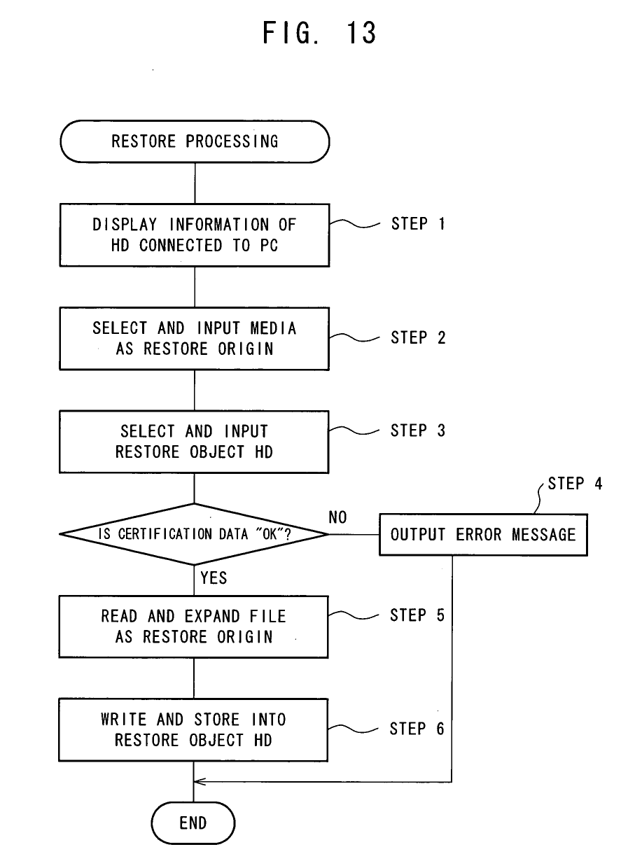

As an execution button is depressed after completion of these inputs in the backup to be performed via the network 3, the parameter creating means 411 acquires an IP address of the backup server 4 and then creates a kernel parameter (Step 4). Subsequently, on a screen as shown in FIG. 15, the user is required and prompted to insert a media such as an FD. After insertion of the FD and depression of an execution button by the user, the formatting means 412 of the backup server 4 commences to format the FD thus inserted (Step 5).

Upon completion of format of the FD, the writing means 413 creates the OS for booting the PC 1 based on the kernel image 46 and kernel parameter and writes that OS into the FD (Step 6). Thus, the boot media 2 dedicated to the PC 1 will be created.

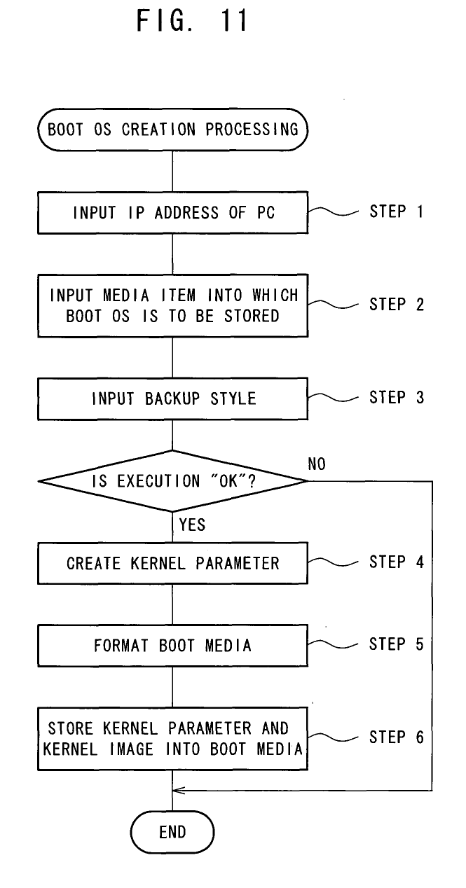

The following description is provided to explain a flow of a backup processing pursued in the backup system of the first embodiment with reference to a flow chart of FIG. 12.

As the user inserts the boot media 2 into the PC 1 as a backed-up object and then powers up the PC 1, the PC 1 is booted by the boot OS 21 installed in the boot media 2 and connected to the backup server 4 via the network 3.

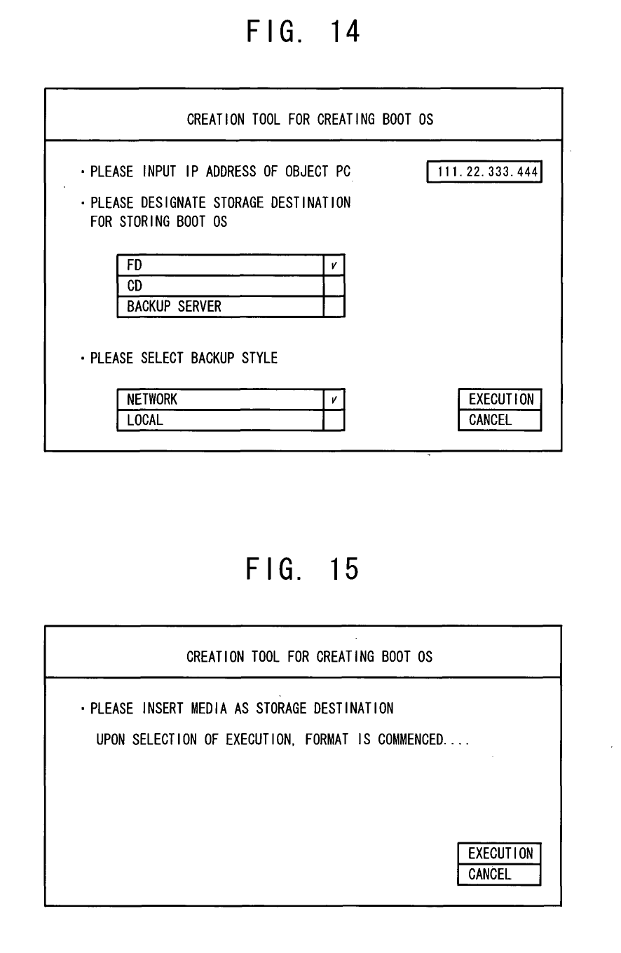

Once the PC 1 connects to the backup server 4, it displays a screen thereon as shown in FIG. 16 by which the user is prompted to select one of service options. If the service option of the backup is selected, information of an HD 6 connected to the PC 1 is displayed on the screen as shown in FIG. 17 (Step 1). Then, the user selects an HD 6 as a backed-up object from the information displayed as above (Step 2). Subsequently, the user inputs one of backup destination options and a file name to be stored into that backup destination (Step 3) and then selects an execution button.

In the first embodiment, the backup server 4 can be designated as the backup destination. In the second embodiment, the magnetic tape device and the like locally connected to the PC 1 can be designated as the backup destination. In the third embodiment, the other storage device connected over the network 3 or the boot media 2 can be designated as the backup destination.

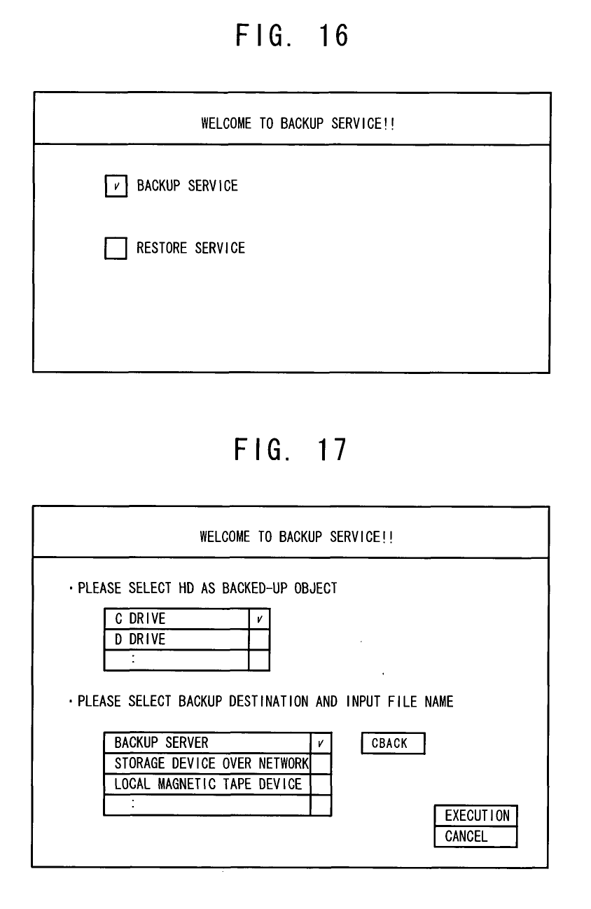

Upon receipt of the execution button, the PC 1 displays a screen as shown in FIG. 18 by which the user is prompted to set and input the password as certification data.

After completion of these inputs, the certification data is stored into the certification DB 45 (Step 4).

Subsequently, unassigned region(s) in the HD 6 of the PC 1 is padded with specific values by the padding means 422 (Step 5). This processing is performed in order to improve compression efficiency.

Subsequently, the content of the HD 6 of the PC 1 is read while being compressed by the reading means 423 (Step 6). Then, backup information is created based on the date and time of backup and information of the HD 6 by the information managing means 421. The resultant backup information is stored along with the compressed data into the backup destination with a designated file name by the writing means 424 (Step 7). As this storage is complete, a screen as shown in FIG. 19 appears so as to end this flow operation.

The following description is provided to explain a flow of restore processing pursued in the backup system of the first embodiment with reference to a flow chart of FIG. 13.

As the user inserts the boot media 2 into a restore object PC 1 and then powers up the PC 1, the PC 1 is booted by the boot OS 21 installed in the boot media 2 and connected to the backup server 4 via the network 3.

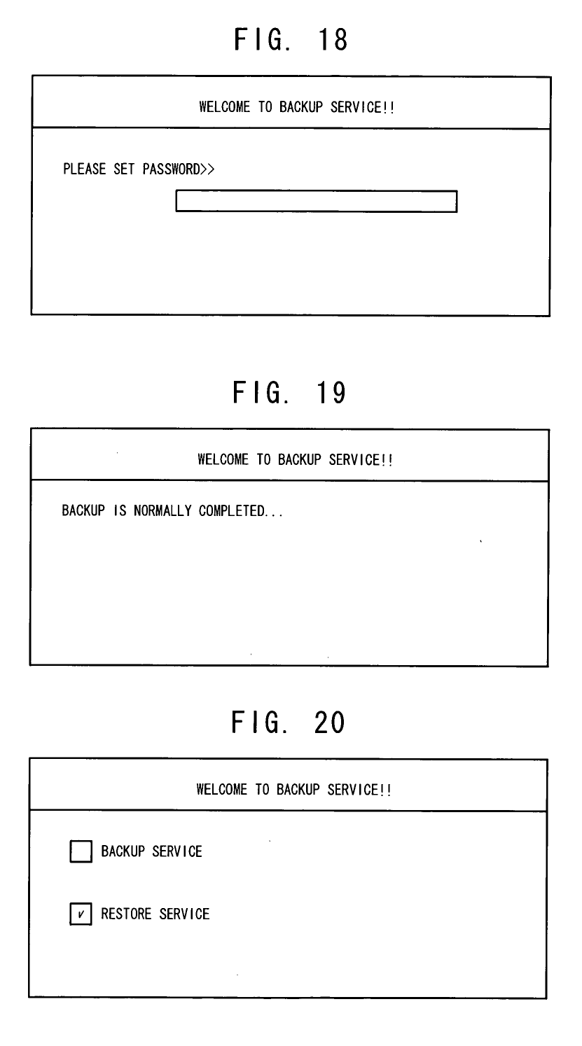

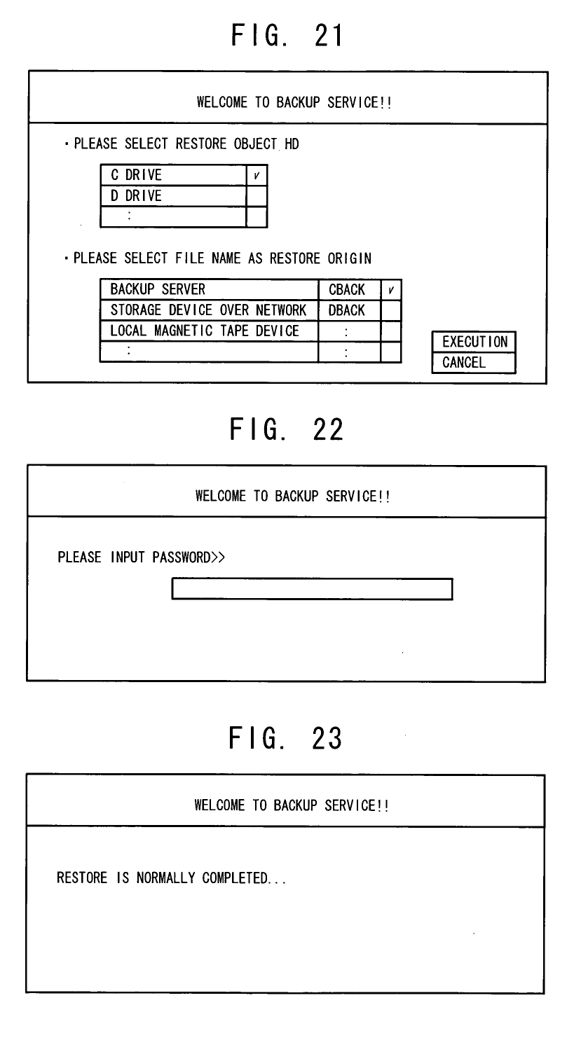

Once the PC 1 connects to the backup server 4, it displays a screen thereon as shown in FIG. 20 by which the user is prompted to select one of service options. If the service option of the restore is selected, information of an HD 6 connected to the PC 1 and the backup data backing up the PC 1 are searched by the information managing means 431 and displayed on the screen as shown in FIG. 21 (Step 1). Then, the user selects a media as the restore origin and its file from various information displayed as above (Step 2) and simultaneously selects the restore object HD 6 (Step 3), thereafter selecting or depressing the execution button. As the restore origin, the backup server 4 can be designated in the first embodiment, the magnetic tape device which is locally connected to the PC 1 can be designated in the second embodiment, and the other storage device 5 which is connected over the network 3 or the boot media 2 can be designated in the third embodiment.

Upon receipt of the execution button, the PC 1 displays a screen as shown in FIG. 22 by which the user is prompted to set and input the password as certification data. After completion of this setting and inputting password, the certifying means 432 determines if the inputted password is valid based on the read information. If the inputted password is invalid, an error message is outputted, thereby ending this restore processing (Step 4). If the inputted password is valid, the reading means 433 reads a file indicated as a restore origin file while expanding it (Step 5) and then the writing means 434 stores it into the HD 6 as the restore destination (Step 6). Upon completion of this storage, a screen as shown in FIG. 23 is displayed, thereby ending this restore processing.

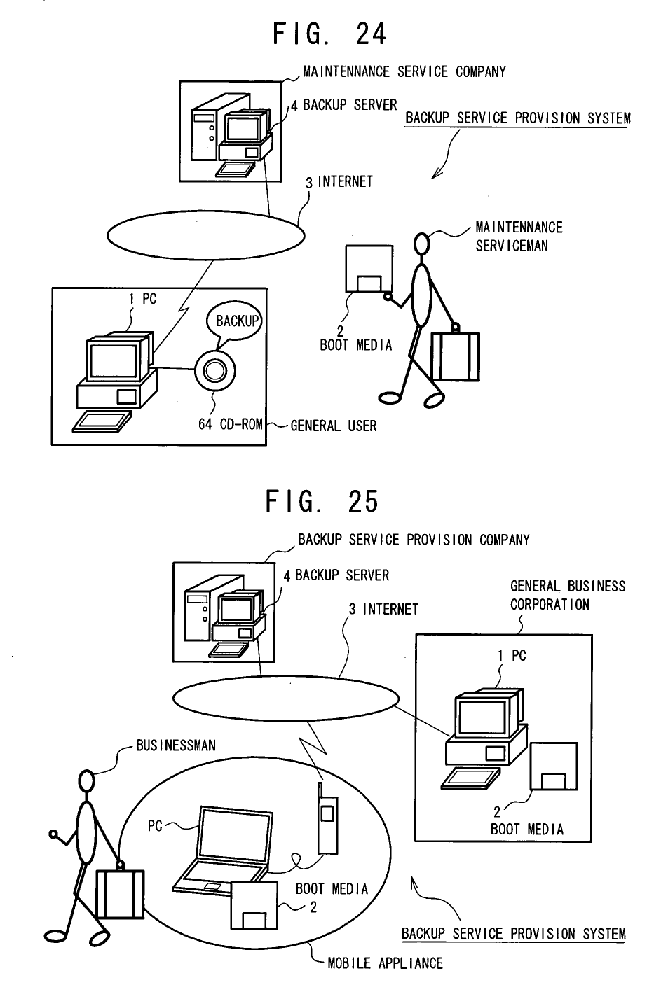

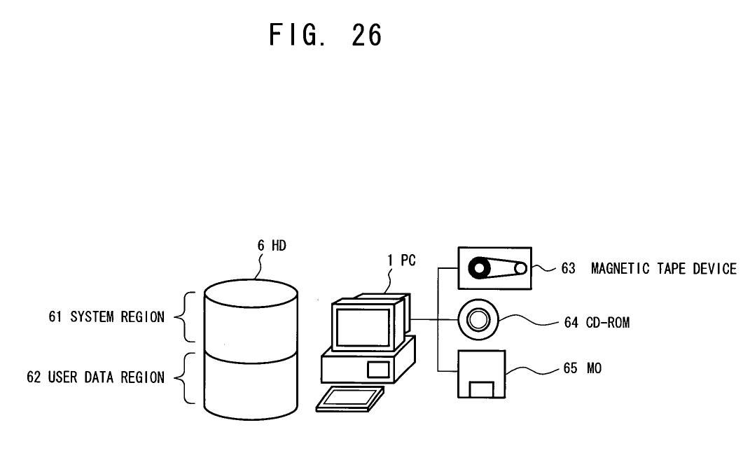

As applications of the present invention, there exist backup service provision systems as shown in FIGS. 24 and 25.

A first example of such applications is a backup service provision system as shown in FIG. 24, where a backup server 4 is located in a maintenance service company. First of all, a user makes a contract for maintenance service, via a network such as the Internet or the other means, by inputting IP address information of a PC 1 which will undergo the maintenance service.

A maintenance serviceman of the maintenance service company will create a boot media 2 for the user's PC 1 thus contracted. Hence, regularly or upon receipt of a request from the user, the maintenance serviceman bears the boot media 2 for the user's PC 1 to the user and boots the user's PC 1 by using this boot media 2 so as to back up the content of the HD 6 into a removable media such as a CD-ROM 64. Also, in response to a request from the user, the maintenance serviceman can restore the backed-up content which has already been stored in the removable media into the HD 6.

With such a backup provision service configuration, it allows the maintenance serviceman to perform the backup and/or restore operations of the content of the HD 6 of the user's PC 1 with ease. Also, it is possible to surely and reliably perform the backup and/or restore operations with respect to the content of the HD 6 of the user's PC 1, without user's special knowledge, merely by making the contract for maintenance service via the network.

A second example of such applications is a backup service provision system as shown in FIG. 25, where a backup server 4 is located in a backup service provision company. First of all, a user makes an application to the backup service provision company for backup service provision, via a network 3 such as the Internet or the other means, by inputting IP address information of a PC 1 which is desired to be backed up. Upon receipt of this application for backup service provision, the backup server 4 causes the parameter creating means 411 in the boot OS creation section 41 to take an IP address of the backup server 4 and create a kernel parameter based on the user's application information. The writing means 413 in the boot OS creation 41 creates a boot OS for booting the PC 1 based on the kernel image 46 and the kernel parameter and stores it as a file. The user is notified that the boot OS is ready.

Upon receipt of this notification, the user downloads the boot OS 21 which has been prepared for the PC 1 and stored in the backup server 4 via the network 3 such as the Internet and stores into an FD or the like of the user.

With this configuration, if the user makes, at his movement destination position, an update of data or an installation of program, the user can back up the content of the HD 6 of the PC 1 by booting the PC 1 from the boot media 2 and then connecting to the backup service provision company. With this backup service provision, the user at the movement destination position can readily perform the backup and/or restore operations of the HD 6 even in his notebook size personal computer which is only equipped with an FD drive.

By providing this backup service using ASP (Application Service Provider) or Hosting service, it is possible to readily perform the backup and/or restore operations of a computer which is employed for performing usual business tasks in a business corporation via the Internet.

With the backup system according to the present invention as described above, it is possible to back up the content of the HD 6 of the PC 1 by an easy manipulation and further possible to restore the backed-up content into the PC 1 by an easy manipulation.

Also, it is possible to restore the backed-up content into a PC other than the PC 1 so that, in the cases where an original PC has been destroyed, a similar PC to the original PC can easily be restored. Further, it is possible to restore a plurality of PC's each having the same content in its HD.

Also, it is possible to perform the backup and/or restore operations through a network. Therefore, in the cases where a user's PC is not equipped with an external storage device of a large capacity, the backup of the user's PC can be performed at any time.

Furthermore, if the backup system according to the present invention is applied to a maintenance service, it is possible to surely and reliably perform the backup and/or restore operations without user's special knowledge.

Also, if the backup service is configured through the Internet, it is possible to easily perform the backup and/or restore operations even at a movement destination.

While preferred exemplary embodiments of the present invention have been described above, it is to be understood that further adaptations of the invention described herein can be obtained by appropriate modifications by one of ordinary skill in the art without departing from the scope of the present invention. Accordingly, although preferred configurations of apparatuses, systems, methods and programs embodying the present invention have been described, it should be understood that these apparatuses, systems, methods and programs may take on a wide variety of configurations and arrangements without departing from the scope of the present invention.

What is claimed is:

1. A backup system for backing up a hard disk of a computer which is connected to a server via a network, characterized in that said server comprises:
a boot OS creation section adapted to create a boot OS for said computer;
a backup section adapted to store as a file the content of the hard disk in said computer into a designated backup destination;
a management information database adapted to store therein management information of said computer; and
a kernel image adapted to serve for the creation of said boot OS.

2. The backup system as claimed in claim 1, wherein said server further comprising a restore section is adapted to restore the content of said hard disk into the same hard disk in said computer or into a hard disk of another computer by using the file which has been stored as a file by said backup section.

3. A backup system for backing up a hard disk of a computer which is connected to a server via a network,
characterized in that said server comprises:
i) a boot OS creation section adapted to create a boot OS for said computer and to store it into a boot media;
ii) a management information database adapted to store therein management information of said computer; and
iii) a kernel image adapted to serve for the creation of said boot OS,
and further characterized in that said boot media comprises:
iv) a backup section adapted to store as a file the content of the hard disk in said computer into a designated backup destination; and
v) a restore section adapted to restore the content of said hard disk into the same hard disk in said computer or into a hard disk of another computer by using the file which has been stored as a file by said backup section.

4. The backup system as claimed in any one of claims 1 to 3, wherein said boot OS creation section includes:
a parameter creating portion adapted to allow said kernel image to serve as said boot OS; and
a writing portion adapted to store said boot OS.

5. The backup system as claimed in any one of claims 1 to 4, wherein said backup section includes:
an information managing portion adapted to manage information for backup;
a reading portion adapted to read the content of the hard disk in said computer while compressing it; and
a writing portion adapted to write said compressed content into said designated backup destination.

6. The backup system as claimed in any one of claims 1 to 4, wherein said restore section includes:
an information managing portion adapted to manage information for restore;
a reading portion adapted to read a file of a restore origin while expanding it; and
a writing portion adapted to write this expanded content into a hard disk as a restore destination.

7. The backup system as claimed in any one of claims 1 to 6, wherein said backup section includes a padding portion adapted to pad an unassigned region in the hard disk in said computer with specific values.

8. The backup system as claimed in any one of claims 5 to 7, wherein said information managing portion included in said backup section is adapted to store certification data, and wherein said restore section includes a certifying portion adapted to perform certification using said stored certification data by said information managing portion included in said restore section.

9. A method of backing up a hard disk connected to a computer, characterized by comprising the steps of:
creating a boot OS for booting said computer by using an external storage device or via a network, independently of an OS installed in said computer as a backed-up object;
booting said computer with said boot OS; and
backing up the content of the hard disk connected to said computer into a server via said network, into a storage medium over said network, or into a storage medium directly connected to said computer.

10. The method as claimed in claim 9, further comprising the step of restoring said content of the hard disk connected to said computer into a hard disk connected to another computer by using a file backing up the content of the hard disk in said computer.

11. A program run in a server or a computer via a network, characterized by comprising:
a creating function adapted to create a boot OS for said computer;
a backup function adapted to store as a file the content of a hard disk in said computer into a designated backup destination; and
a restore function adapted to restore the content of said hard disk into the same hard disk in said computer by using the file which has been stored as a file by said backup function.

12. A backup service provision system for providing a backup of a hard disk of a computer connected to a server via the Internet, characterized in that said server comprises:
a boot OS creating section adapted to create a boot OS for said computer;
a backup section adapted to store as a file the content of the hard disk in said computer into a designated backup destination;
a management information database adapted to store management information for said computer; and
a kernel image adapted to serve for the creation of said boot OS, and
wherein said backup service provision system is configured to back up any computers connectable to said server.

13. The backup service provision system as claimed in claim 12, wherein said server further comprises a restore section adapted to restore the content of said hard disk into the same hard disk in said computer by using the file which has been stored as a file by said backup section.
